(19) United States
(12) Patent Application Publication
(10) Pub. No.: US 2026/0241871 A1
(43) Pub. Date: Aug. 20, 2026

(54) STORAGE FOR MOBILE PHONES IN A VEHICLE

(71) Applicant: AUDI AG, lngolstadt (DE)

(72) Inventor: Jacques HÉLOT, lngolstadt (DE)

(73) Assignee: AUDI AG, lngolstadt (DE)

(21) Appl. No.: 19/471,176

(22) PCT Filed: Jun. 17, 2024
(86) PCT No.: PCT/EP2024/066755

§ 371 Date: Sep. 30, 2025

(30) Foreign Application Priority Data
Jun. 22, 2023 (DE) 102023116457.0

(51) Int. Cl. B60R 11/02; B60R 11/00

(52) U.S. Cl. CPC B60R 11/0241; B60R 2011/0007; B60R 2011/0075

(57) ABSTRACT

A storage for mobile phones in a vehicle. A coupling box in which two coupling regions are formed, each for a mobile phone, and a separating device, the two coupling regions are each associated with a vehicle seat and are arranged within the field of vision of occupants on the two vehicle seats. The separating device includes a movable separating wall which can be extended from a retracted storage position, in which both coupling regions and screens of mobile phones stored therein are visible to both occupants, into a separating position, in which the occupants can only see one coupling region associated with their vehicle seat and one screen of a mobile phone stored therein, as well as to a vehicle with at least one such storage for mobile phones.

### FIELD

The invention relates to a storage for mobile phones in a vehicle. The invention further relates to a vehicle having at least one such storage.

### BACKGROUND

There are many different types of cell phone storages in vehicles. Such a storage usually comprises a coupling box in which a mobile phone can be stored and charged wirelessly. Storages for mobile phones are also known from the prior art, in which two mobile phones belonging to two occupants, for example a driver and a passenger, can be stored next to each other. The two mobile phones are positioned within the field of vision of both occupants. Since both mobile phones are connected to the cellular network while driving, messages such as text messages, new social media posts and/or calendar reminders, etc., can appear on the screens of both mobile phones and can be viewed by both occupants. This can result in one occupant receiving information that the other occupant would prefer to keep private.

DE 10 2018 000 493 A1 discloses a holder for positioning a smartphone in a vehicle. The holder comprises a swivel arm connected to a spring drive and a cover for covering the smartphone when not in use, which is coupled to a push-to-open mechanism by means of which the spring drive of the swivel arm can be triggered to release the smartphone through the cover.

From DE 10 2006 008 420 A1 a device holder for an electronic device for installation in a motor vehicle is known. The device holder is part of a compartment having an opening at the upper side and can be pivoted relative to the compartment between a non-use position, in which the device holder is accommodated in the compartment, and a use position, in which the device holder is pivoted out of the compartment. In addition, the compartment has a closure to close its opening. In addition to a closed position that completely closes the opening, the closure can be brought into a further closed position in which, when the device holder is swung out of the compartment, the remaining opening is at least largely closed.

### SUMMARY

The invention is based on the object of providing a storage for mobile phones in a vehicle and a vehicle with at least one such storage for mobile phones, which improves the comfort of storing mobile phones in the vehicle.

In order to provide a storage space for mobile phones in a vehicle, comprising a coupling box, in which two coupling regions are formed, each for a mobile phone, and a separating device, which cost-effectively improves the comfort of storing mobile phones in the vehicle, the two coupling regions are each associated with a vehicle seat and are arranged in the field of vision of occupants on the two vehicle seats. The separating device comprises a movable separating wall which can be extended from a retracted storage position, in which both coupling regions and screens of mobile phones stored therein are visible to both occupants, into a separating position in which the occupants can only see a coupling region associated with their vehicle seat and a screen of a mobile phone stored therein.

In addition, a vehicle with at least one such storage for mobile phones is proposed.

By means of embodiments of the mobile phone storage according to the invention, the view of one's own mobile phone can be controlled with the movable separating wall and the confidentiality of the messages displayed on the mobile phone screen can be maintained in the extended separating position. When extended, the movable separating wall provides effective protection from messages displayed on the mobile phone screen from the person sitting next to them. If there is no problem with confidentiality, the movable separating wall can be moved into the retracted storage position.

In an advantageous embodiment of the storage, the movable separating wall of the separating device can be arranged largely in a receiving space in the retracted storage position or largely outside the receiving space in the extended separating position. The receiving space can be formed outside the coupling box, for example in a cavity in a center console. Alternatively, the receiving space within the coupling box can be formed in a fixed separating wall which is arranged between the two coupling regions.

In a further advantageous embodiment of the storage, the separating device can comprise an actuating device which is designed to move the movable separating wall from the retracted storage position into the extended separating position or from the extended separating position into the retracted storage position. Preferably, the manual actuating device may comprise a simple, low-cost mechanism for moving the separating wall between the storage position and the separating position or between the separating position and the storage position. Alternatively, the actuating device may comprise a drive which can be activated by an actuating element and can move the movable separating wall from the retracted storage position to the extended separating position or from the extended separating position to the retracted storage position.

In a particularly advantageous and cost-effective embodiment of the storage, the actuating device can comprise a push-push mechanism with at least one spring element, which can be triggered by manual pressure on the movable separating wall. The movable separating wall can be moved here from the retracted storage position into the extended separating position by a spring force of at least one spring element of the push-push mechanism. The movable separating wall can also be moved manually from the retracted storage position into the extended separating position against the spring force of the at least one spring element of the push-push mechanism. The push-push mechanism design enables simple and cost-effective implementation of the holding device.

In a further advantageous embodiment of the storage, the movable separating wall can be held in the retracted storage position by means of a locking mechanism.

In a further advantageous embodiment of the storage, the movable separating wall can be guided in a guide gap formed in a wall of the coupling box or in the fixed separating wall. In this case, the movable separating wall can be held in the extended separating position by a stop of the guide gap.

In a further advantageous embodiment of the storage, the coupling box can have at least one electrical charging device for charging an electrical energy storage of the mobile phone stored in one of the coupling regions. Preferably, the charging device comprises at least one transponder coil so that the electrical energy storage of the stored mobile phones can be charged wirelessly. Of course, the respective charging device can additionally or alternatively have a plug contact for a wired charging of the electrical energy storage of the stored mobile phone.

In an advantageous embodiment of the vehicle, the storage can be arranged between two adjacent vehicle seats. Preferably, the storage can be arranged in a center console between a driver's seat and a passenger seat. Additionally or alternatively, the storage can be arranged between two seats in the rear region of the vehicle.

The advantages and preferred embodiments described for the storage for mobile phones according to the invention also apply to the vehicle according to the invention.

The features and combinations of features mentioned above in the description as well as the features and feature combinations mentioned below in the description of the figures and/or merely shown in the figures may be used not only in the combination specified, but also in other combinations or alone, without departing from the scope of the invention. The invention should therefore also be considered to comprise and disclose embodiments that are explicitly not shown or explained in the figures, but emerge and can be created from the explained embodiments by separate feature combinations.

### BRIEF DESCRIPTION OF THE FIGURES

An exemplary embodiment of the invention is illustrated in the drawings and will be described in greater detail in the following description. In the drawings, identical reference numerals designate components or elements that perform identical or analogous functions. In the figures:

FIG. 1 shows a schematic and partial representation of a first exemplary embodiment of a storage according to the invention for mobile phones in a vehicle, with a separating wall in a retracted storage position;

FIG. 2 shows a schematic and perspective view of the storage according to the invention for mobile phones in a vehicle, with the separating wall in an extended separating position, and

FIG. 3 shows a schematic and partial representation of a second embodiment of a storage according to the invention for mobile phones in a vehicle, with a separating wall in an extended separating position.

### DETAILED DESCRIPTION

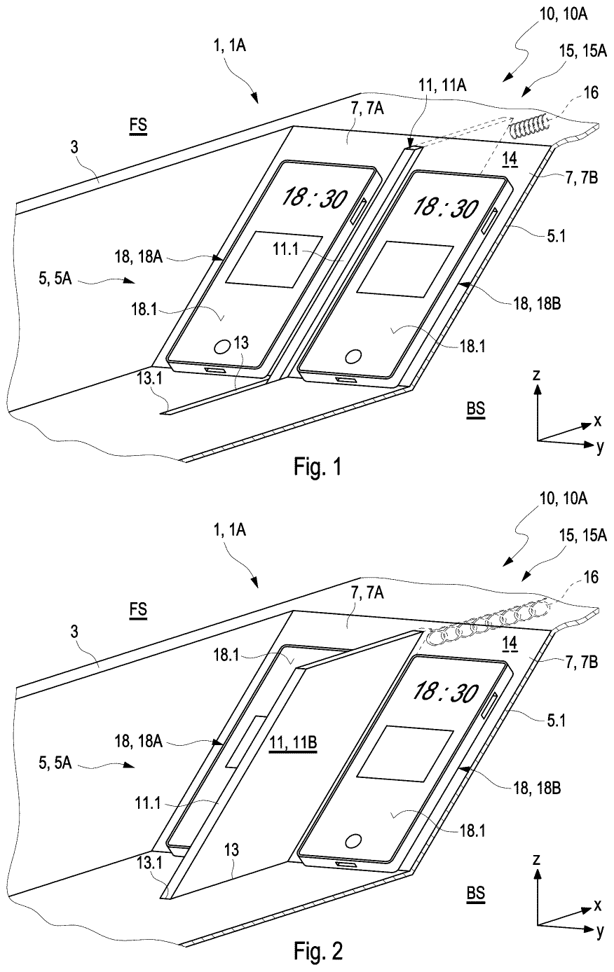

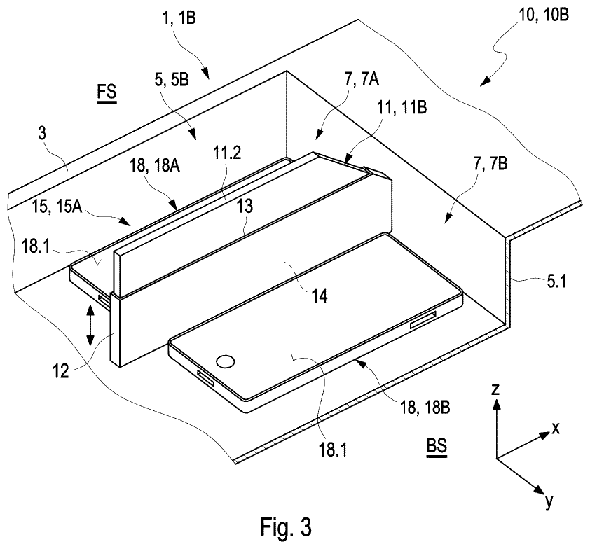

As can be seen from FIGS. 1 to 3, the illustrated exemplary embodiments of a storage 1 according to the invention for mobile phones 18 in a vehicle comprise a coupling box 5, in which two coupling regions 7 are formed, each for a mobile phone 18, and a separating device 10. The two coupling regions 7 are each associated with a vehicle seat and are arranged in the field of vision of occupants on the two vehicle seats. The separating device 10 comprises a movable separating wall 11 which can be extended from a retracted storage position 11A shown in FIG. 1, in which both coupling regions 7 and screens 18.1 of mobile phones 18 stored therein are visible to both occupants, into a separating position 11B shown in FIG. 2 or FIG. 3, in which the occupants can only see a coupling region 7 associated with their vehicle seat and a screen 18.1 of a mobile phone 18 stored therein.

The storage 1 for mobile phones 18 is arranged in the vehicle between two adjacent vehicle seats not shown in detail. In the illustrated exemplary embodiment, the storage 1 is arranged in a center console 3 between a driver's seat and a passenger seat.

In an alternative embodiment not shown, the storage 1 is additionally or alternatively arranged between two adjacent vehicle seats in the rear region of the vehicle.

In the first exemplary embodiment of the storage 1A shown in FIGS. 1 and 2, a first coupling region 7A, in which a first mobile phone 18A is stored, is formed on an inclined end wall 5.1 of the coupling box 5A and is associated with the driver's seat (not shown in detail) arranged on a driver's side FS of the vehicle. A second coupling region 7B, in which a second mobile phone 18B is stored, is formed next to the first coupling region 7A on the inclined front wall 5.1 of the coupling box 5A and is associated with the passenger seat (not shown in detail) arranged on a passenger side BS of the vehicle.

As can be further seen from FIG. 1, in the illustrated retracted storage position 11A of the movable separating wall 11, the first coupling region 7A associated with the driver's seat and the screen 18.1 of the first mobile phone 18A of the driver are visible to the passenger from the passenger side. As can be further seen from FIG. 2, in the illustrated extended separating position 11B of the movable separating wall 11, the first coupling region 7A associated with the driver's seat and the screen 18.1 of the first mobile phone 18A of the driver are not visible to the passenger from the passenger side.

As can be further seen from FIGS. 1 and 2, the separating device 10A in the illustrated first exemplary embodiment of the storage 1A comprises an actuating device 15, by means of which the movable separating wall 11 can be moved from the retracted storage position 11A into the extended separating position 11B or from the extended separating position 11B into the retracted storage position 11A.

In the illustrated first exemplary embodiment of the storage 1A, the actuating device 15 comprises a push-push mechanism 15A with at least one spring element 16, which can be triggered by manual pressure on an end side 11.1 of the movable separating wall 11. The movable separating wall 11 can be moved from the retracted storage position 11A to the extended separating position 11B by a spring force of at least one spring element 16 of the push-push mechanism 15A. For this purpose, the separating wall 11 is guided in a guide gap 13 provided in the coupling box 5A. As can be further seen from FIGS. 1 and 2, the guide gap 13 in the illustrated first exemplary embodiment of the storage 1A is provided in a bottom and in the inclined end wall 5.1 of the coupling box 5A. Moreover, the movable separating wall 11 can be manually moved from the extended separating position 11B into the retracted storage position 11A against the spring force of at least one spring element 16 of the push-push mechanism 15A. For this purpose, the movable separating wall 11 is moved by manual pressure on the end side 11.1 from the extended separating position 11B until it locks into the retracted storage position 11A.

As can be further seen from FIGS. 1 and 2, the larger part of the movable separating wall 11 in the retracted storage position 11A shown in FIG. 1 is received by a receiving space 14 formed behind the inclined front wall 5.1 of the coupling box 5 in a cavity of the center console 3, so that only a front end region in the coupling box 5A is arranged outside the receiving space 14. The movable separating wall 11 is held in the retracted storage position 11A by means of a locking mechanism not shown in detail. In the extended separating position 11B shown in FIG. 2, the movable separating wall 11 rests with an end side 11.1 of the front end region against a stop 13.1 of the guide gap 13, so that only a rear end region of the movable separating wall 11 is arranged within the receiving space 14. A spring element 16 of the push-push mechanism 15A, designed as a compression coil spring, is also arranged in the receiving space 14. As can be further seen from FIG. 1, the spring element 16 of the push-push mechanism 15A, which is designed as a compression coil spring, is in a loaded state in the retracted storage position 11A of the movable separating wall 11. As can be further seen from FIG. 2, the spring element 16 of the push-push mechanism 15A, which is designed as a compression coil spring, is in an unloaded state in the extended separating position 11B of the movable separating wall 11.

In the second exemplary embodiment of the storage 1B shown in FIG. 3, a first coupling region 7A, in which a first mobile phone 18A is stored, is formed on the bottom of the coupling box 5B in the region of the front wall 5.1 and is associated with the driver's seat, not shown in detail, arranged on a driver's side FS of the vehicle. A second coupling region 7B, in which a second mobile phone 18B is stored, is formed next to the first coupling region 7A on the bottom of the coupling box 5B in the region of the front wall 5.1 and is associated with the passenger seat, not shown in detail, arranged on a passenger side BS of the vehicle.

As can be further seen from FIG. 3, in the illustrated extended separating position 11B of the movable separating wall 11, the first coupling region 7A associated with the driver's seat and the screen 18.1 of the first mobile phone 18A of the driver are not visible to the passenger from the passenger side. In the not illustrated retracted storage position 11A of the movable separating wall 11, the first coupling region 7A associated with the driver's seat and the screen 18.1 of the first mobile phone 18A of the driver are visible to the passenger from the passenger side.

As can be further seen from FIG. 3, the separating device 10B in the illustrated second exemplary embodiment of the storage 1B comprises an actuating device 15, by means of which the movable separating wall 11 can be moved from the retracted storage position into the extended separating position 11B or from the extended separating position 11B into the retracted storage position.

As can be further seen from FIG. 3, the separating device 10B in the illustrated second exemplary embodiment comprises a fixed separating wall 12, which is arranged between the two coupling regions 7 at the bottom of the coupling box 5. The fixed separating wall 12 has a receiving space 14 in which the larger part of the movable separating wall 11 is received in the retracted storage position 11A, not shown, so that only an upper end region with an upper side 11.2 of the movable separating wall 11 is arranged in the coupling box 5B outside the receiving space 14.

Analogous to the first exemplary embodiment of the storage 1A, the actuating device 15 in the illustrated second embodiment of the storage 1B comprises a push-push mechanism 15A with at least one non-visible spring element, which can be triggered by manual pressure on the upper side 11.2 of the movable separating wall 11. The movable separating wall 11 can be moved from the retracted storage position, not shown, into the extended separating position 11B shown in FIG. 3 by a spring force of the at least one spring element of the push-push mechanism 15A. For this purpose, the separating wall 11 is guided in a guide gap 13 provided in the fixed separating wall 12. The movable separating wall 11 is held in the retracted storage position 11A by means of a locking mechanism not shown in detail. In the extended separating position 11B shown in FIG. 3, the movable separating wall 11 rests in a lower end region against a non-visible stop of the guide gap 13, so that only a rear end region of the movable separating wall 11 is arranged within the receiving space 14. Moreover, the movable separating wall 11 can be manually moved from the extended separating position 11B into the retracted storage position against the spring force of at least one spring element of the push-push mechanism 15A. For this purpose, the movable separating wall 11 is moved by manual pressure on the upper side 11.2 from the extended separating position 11B until it locks into the retracted storage position. The above-mentioned at least one spring element of the push-push mechanism 15A is also arranged in the receiving space 14.

In an alternative exemplary embodiment of the storage 1 for mobile phones 18 in a vehicle, not shown, the actuating device 15 comprises a drive which can be activated by an actuating element and moves the movable separating wall 11 from the retracted storage position 11A into the extended separating position 11B or from the extended separating position 11B into the retracted storage position 11A.

In the illustrated exemplary embodiments of the storage 1, the two coupling regions 7 each have an electrical charging device, not shown, for charging an electrical energy storage of the mobile phone 18 stored in the respective coupling region 7.

### LIST OF REFERENCE NUMERALS

1, 1A, 1B storage
3 center console
5, 5A, 5B coupling box
5.1 front wall
7, 7A, 7B coupling region
10, 10A, 10B separating device
11, 11A, 11B movable separating wall
11.1 end side
11.2 upper side
12 fixed separating wall
13 guide gap
13.1 stop
14 receiving space
15 actuating device
15A push-push mechanism
16 spring element
18, 18A, 18B mobile phone
18.1 screen
X vehicle longitudinal direction
y vehicle transverse direction
Z vehicle vertical direction
BS passenger side

1.-15. (Canceled)

16. A storage for mobile phones in a vehicle, comprising a coupling box in which two coupling regions are formed, each for a mobile phone, and a separating device, wherein the two coupling regions are each associated with a vehicle seat and are arranged within the field of vision of occupants on the two vehicle seats, wherein the separating device comprises a movable separating wall which can be extended from a retracted storage position, in which both coupling regions and screens of mobile phones stored therein are visible to both occupants, into a separating position, in which the occupants can only see one coupling region associated with their vehicle seat and one screen of a mobile phone stored therein.

17. The storage according to claim 16, wherein the movable separating wall of the separating device is arranged mostly in a receiving space in the retracted storage position or mostly outside the receiving space in the extended separating position.

18. The storage according to claim 17, wherein the receiving space is formed outside the coupling box or inside the coupling box in a fixed separating wall which is arranged between the two coupling regions.

19. The storage according to claim 16, wherein the separating device comprises an actuating device which is designed to move the movable separating wall from the retracted storage position into the extended separating position or from the extended separating position into the retracted storage position.

20. The storage according to claim 19, wherein the actuating device comprises a drive which can be activated by an actuating element and moves the movable separating wall from the retracted storage position to the extended separating position or from the extended separating position to the retracted storage position.

21. The storage according to claim 19, wherein the actuating device comprises a push-push mechanism with at least one spring element, which can be triggered by manual pressure on the movable separating wall.

22. The storage according to claim 21, wherein the movable separating wall can be moved from the retracted storage position into the extended separating position by a spring force of at least one spring element of the push-push mechanism.

23. The storage according to claim 21, wherein the movable separating wall can be manually moved from the extended separating position into the retracted storage position against the spring force of at least one spring element of the push-push mechanism.

24. The storage according to claim 21, wherein the movable separating wall is held in the retracted storage position by means of a locking mechanism.

25. The storage according to claim 16, wherein the movable separating wall is guided in a guide gap provided in a wall of the coupling box or in the fixed separating wall.

26. The storage according to claim 25, wherein the movable separating wall is held in the extended separating position by a stop of the guide gap.

27. The storage according to claim 16, wherein the coupling box has at least one electrical charging device for charging an electrical energy storage of the mobile phone stored in one of the coupling regions.

28. A vehicle with at least one storage for mobile phones, which is designed according to claim 16.

29. The vehicle according to claim 28, wherein the storage is arranged between two adjacent vehicle seats.

30. The vehicle according to claim 28, wherein the storage is arranged in a center console of the vehicle.

31. The storage according to claim 17, wherein the separating device comprises an actuating device which is designed to move the movable separating wall from the retracted storage position into the extended separating position or from the extended separating position into the retracted storage position.

32. The storage according to claim 18, wherein the separating device comprises an actuating device which is designed to move the movable separating wall from the retracted storage position into the extended separating position or from the extended separating position into the retracted storage position.

33. The storage according to claim 22, wherein the movable separating wall can be manually moved from the extended separating position into the retracted storage position against the spring force of at least one spring element of the push-push mechanism.

34. The storage according to claim 22, wherein the movable separating wall is held in the retracted storage position by means of a locking mechanism.

35. The storage according to claim 23, wherein the movable separating wall is held in the retracted storage position by means of a locking mechanism.
